(19) United States
(12) Patent Application Publication
(10) Pub. No.: US 2022/0400187 A1
(43) Pub. Date: Dec. 15, 2022

(54) UPDATING A COLOR PROFILE

(71) Applicant: Hewlett-Packard Development Company, L.P., Spring, TX (US)

(72) Inventors: Jordi ARNABAT BENEDICTO, Sant Cugat del Valles (ES); Jan MOROVIC, London (GB); Peter MOROVIC, Sant Cugat del Valles (ES)

(73) Assignee: Hewlett-Packard Development Company, L.P., Spring, TX (US)

(21) Appl. No.: 17/770,227

(22) PCT Filed: Jan. 24, 2020
(86) PCT No.: PCT/US2020/014966

§ 371 Date: Apr. 19, 2022

(51) Int. Cl. H04N 1/60

(52) U.S. Cl. CPC H04N 1/603

(57) ABSTRACT

Disclosed is a non-transitory computer readable storage medium, a computer-implemented method and an imaging color profile of an imaging apparatus. A processor retrieves the color profile of the imaging apparatus from data storage, the color profile comprising a first plurality of associations between a first plurality of color values in a first color space and a second plurality of color values in a second color space. The processor receives input data indicating a determined association, the determined association being an association between a first determined color value in the first color space and a second determined color value in the second color space. The processor performs an update process to update the first plurality of associations, the update process comprising performing an interpolation process using the determined association and an association of the first plurality of associations.

### BACKGROUND

In some imaging apparatuses, a color profile may define a mapping between a device source color space and an output color space. The device source color space may comprise a red, green and blue (RGB) color space or a cyan, magenta, yellow and black (CMYK) color space, for example. The output color space may be a color space defined by the International Commission on Illumination (CIE), such as a CIELAB, expressing colors as three values (LAB representing the lightness from black to white, from green to red and from blue to yellow, respectively) color space in which colors are expressed or a CIEXYZ (XYZ representing the tristimulus values perceived by the human eye) color space. Mappings can be specified using tables, to which interpolation is applied, or through a series of parameters for transformations, for example.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of an apparatus to update a color profile of an imaging apparatus;

FIG. 2 is a flow diagram illustrating a method of updating a color profile of an imaging apparatus;

FIG. 3a is a flow diagram representing a first method of updating a color profile of an imaging apparatus and an example of a shape with coordinates of color values of a color space;

FIG. 3b is a diagram illustrating a modification of a shape in a color space;

FIG. 4a is a flow diagram representing a second method of updating a color profile of an imaging apparatus;

FIGS. 4b and 4c illustrate an example of a modification to a tessellation in a color space.

### DETAILED DESCRIPTION

In the following description, for purposes of explanation, numerous specific details of certain examples are set forth. Reference in the specification to “an example” or similar language means that a particular feature, structure, or characteristic described in connection with the example is included in that one example, but not necessarily in other examples.

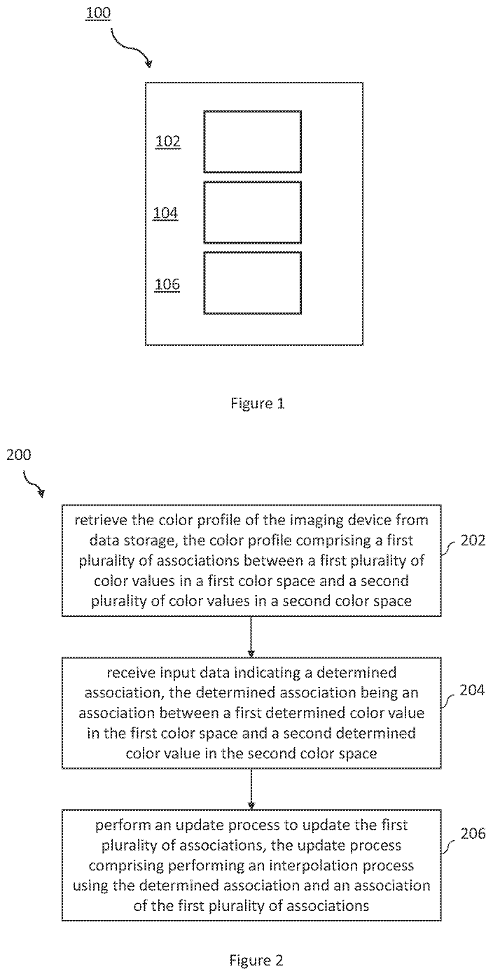

FIG. 1 schematically illustrates an imaging apparatus 100 to update a color profile of the imaging apparatus 100 according to an example. The imaging apparatus 100 comprises a processor 102 which performs an update of the color profile of the imaging apparatus 100.

In an example, the processor 102 is in communication with a non-transitory computer readable storage medium 104 to store the color profile of the imaging apparatus 100. The non-transitory computer readable storage medium 104 may be a read only memory (ROM) or a read-write memory, for example. The non-transitory computer readable storage medium 104 (hereinafter “storage medium 104”) may be in the form of compact disk (CD), a digital versatile disk (DVD), hard disk drive, solid state drive, a flash memory device and the like.

In an example, the storage medium 104 has instructions stored thereon, which, when executed by a processor (in this instance, the processor 102), causes the processor to update the color profile of the imaging apparatus 100.

In this example, the processor 102 is in communication with an interface 106 to receive input data indicating a determined association between a first determined color value in the first color space and a second determined color value in the second color space.

The interface 106 may be a user interface comprising a user input means, such as a keypad or a touchscreen. A user may use the interface 106 to enter color values on the basis of which the processor 102 updates the color profile, as described below.

The imaging apparatus 100 may be an apparatus which produces as image such as a printing system, a camera or general-purpose computer monitor, for example.

In the following description, methods of updating a color profile are described as being performed by the imaging apparatus whose color profile is to be updated. However, in some examples, the methods are performed by a different apparatus, for example a computing device separate from the imaging apparatus whose color profile is to be updated. For example, the color profile of the imaging apparatus may be provided to a memory of the computing device and updated according to methods disclosed herein.

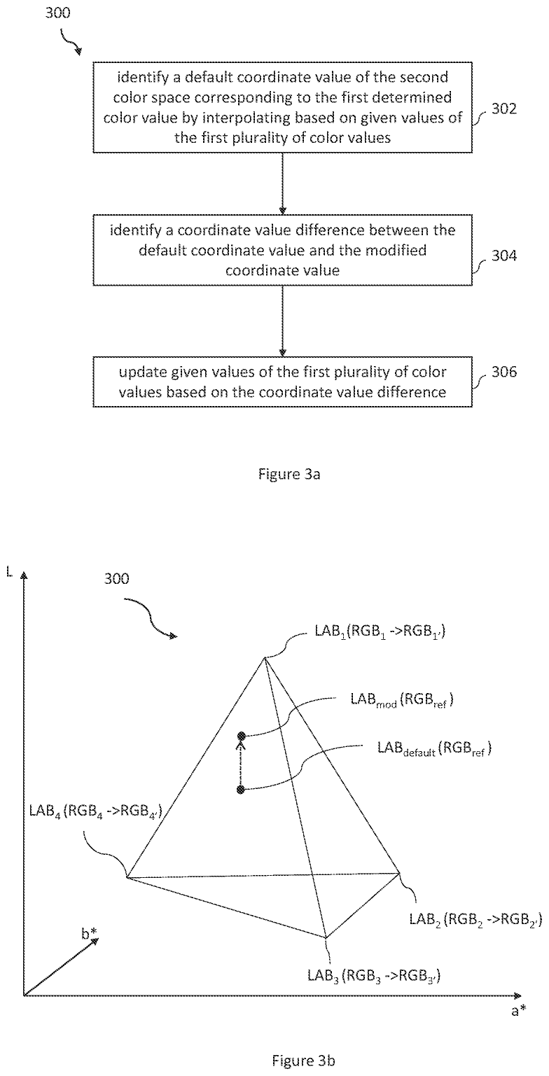

FIG. 2 illustrates a method 200 for updating a color profile of an imaging apparatus 100 according to an example. The processor 102 may perform the method 200 when the instruction stored in the storage medium 104 and received at the interface 106 are executed by the processor 102. When operating under the control of the instructions, the processor 102 may operate as a controller, such as a control management module (CMM) of the imaging apparatus 100.

At block 202 of the method 200, the color profile of an imaging apparatus 100 is retrieved from a data storage. The color profile comprises a first plurality of associations between a first plurality of color values of a first color space and a second plurality of color values of a second color space. One of the first color space and the second color space may be a source color space of the imaging apparatus and the other of the first color space and the second color space may be an output color space of the imaging apparatus.

The color profile of the imaging apparatus may be an international color consortium (ICC) profile mapping the available color values of an imaging apparatus. The color profile may comprise a look-up table (LUT) associating (e.g. relating) each source color value (e.g. an RGB or CMYK value) to a corresponding output color value (e.g. a CIELAB or CMZY value). The source color space may be an RGB or CMYK color space and the output color space may be a CIELAB or CIEXYZ color space, for example. The output color space may thus define the range of colors which the imaging apparatus 100 is capable of producing (e.g. which a printer is capable of printing or a monitor is capable of displaying). Some examples described herein are described with reference to RGB and LAB color spaces. It will be appreciated that these examples apply equally to other color spaces, such as CMYK and XYZ color spaces.

Values in the input color space may define input parameters for the imaging apparatus 100. For example, in the case that the imaging apparatus 100 is a printing system, the output color values may each represent colors to be produced as a result of printing content with the corresponding source color values. The source color values may each represent a set of parameters such as parameters relating to ink to be used to be used in order that content printed according to the source color value has a color conforming to the corresponding output color value. The source values may thus be used as part of printing data representing the printing content to be printed. Each of the first plurality of color values may represent a set of coordinate values of a first color space and each of the second plurality of color values may represent a set of coordinate values of the second color space.

The color profile thus provides a mapping between color spaces, with each of the second color values representing a set of coordinates of a vertex of a shape (for example, a 3-dimensional or 4-dimensional shape) in the second color space, and the corresponding first color values representing values of the first color space corresponding to each of the vertices. Each of the first and second color spaces may be tessellated according to such shapes. These shapes may be referred to as “tessella”.

When a color is to be output which is not included in the color profile of the imaging apparatus 100 (e.g. there is a no value exactly corresponding to the desired value in a LUT of the color profile), an interpolation scheme associated with the imaging apparatus 100 may be used to obtain the value. Data representing the interpolation scheme may be stored in the storage medium 104, for example. The interpolation scheme may be a linear interpolation scheme, such as a trilinear or quadrilinear interpolation scheme, or a simplicial interpolation scheme, such as a pentahedral, tetrahedral or cubic interpolation scheme, for example.

At block 204, the processor 102 receives input data indicating a determined association, the determined association being an association between a first determined color value of the first color space and a second determined color value of the second color space, the determined association being different from each of the first plurality of associations.

The input data may be derived from data entered by a user at the interface 106, for example. For example, in the case the imaging apparatus 100 is a printing system, the input data may be based on a matching process of printed content. For example, a user may compare printed content with samples having specified LAB values. The samples may be brand or corporate identify colors, for example. The LAB value of a sample which most closely matches (e.g. by visual inspection) with the printed content may be entered into the interface, this entered value being an example of the second determined color value. An RGB value used by the imaging apparatus 100 to produce the content having the LAB value measured according to the above process is an example of the first determined color value. This RGB value may also be entered by a user via the interface 106, or the imaging apparatus 100 may store the value used to perform the e.g. printing process and associate the stored value with the entered LAB value on input of the LAB value.

In other examples, the imaging apparatus 100 may produce image files, such as digital files which may be decoded into raster and vector content from where color values (e.g. LAB values) can be extracted and provided via the interface 106. This may involve the use quantization algorithms, median cut or octree techniques to reduce the set of output color space colors produced according to input color spaces listed in the color profile (which may be referred to as a “palette”) to the desired size.

At block 206, the processor 102 performs an update process to update the first plurality of associations, the update process comprising performing an interpolation process using the determined association and an association of the first plurality of associations.

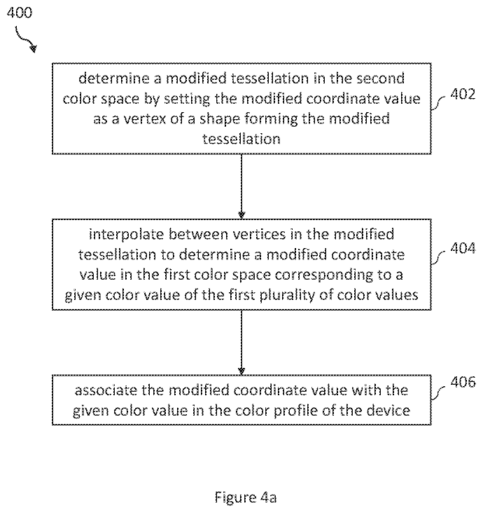

FIG. 3a illustrates a first example update process 300 to update the color profile of an imaging apparatus 100. The first example update process 300 may be used when the interpolation scheme used by imaging apparatus 100, as described above, is available e.g. known to the function (e.g. machine-readable instructions) implementing the update process 300.

At block 302, the processor 102 identifies a default coordinate value of the second color space corresponding to the first determined color value by interpolating, using an interpolation scheme associated with the color profile of the imaging apparatus, based on given values of the first plurality of color values, the given values being associated in the color profile with color values of the second color space representing coordinate values of the vertices of a shape containing the default value.

As described above, the second color value may be a measured value in the second color space, corresponding to the first determined color. The second determined color value may represent a modified value of the second color space. For example, the modified value may be a value desired to be obtained using an interpolation scheme associated with the imaging apparatus 100. In this example, the default coordinate value of the second color space is a coordinate value corresponding to the first determined color value as calculated using the interpolation scheme associated with the color profile of the imaging apparatus. This default coordinate value may differ from the measured value due to differences between characteristics of the imaging apparatus 100 assumed when creating the color profile and the actual characteristics of the imaging apparatus, for example.

In this example, the given values are interpolation values used by the interpolation scheme to obtain the default value. The given values may be selected as those associated, in the color profile, with color values of the second color space corresponding (e.g. comprising the coordinate values of) vertices of the shape (tessellar) in the second color space enclosing the default value (e.g. the shape in which the default value lies).

FIG. 3b illustrates an example of a modification of color values associated with a shape in the second color space with color values in accordance with an example. In this example, the shape is a tetrahedron in LAB space, with RGB values associated with each of the vertices. The tetrahedron has vertices at coordinates LAB₁, LAB₂, LAB₃ and LAB₄. Prior to the update process being performed, the vertices are associated with RGB values RGB₁, RGB₂, RGB₃ and RGB₄, respectively. The default coordinate value determined according to the interpolation process is LAB_{default} and is associated with the first determined color value (labelled RGB_{ref}) derived from the input data. The modified coordinate value received via the input data is indicated as LAB_{mod}.

At block 304, the processor identifies a coordinate value difference between the default coordinate value and the modified coordinate value. The coordinate value difference between the default coordinate value and the coordinate value is, for example, a vector distance. This is illustrated in FIG. 3b by the arrow pointing from LABdefault to LAB_{mod}.

At block 306, the given values of the second plurality of color values are updated based on the difference value obtained at block 304. The update may reduce or eliminate the coordinate value difference between the default coordinate value and the modified coordinate value. For example, modified color values for the given values are selected such that when the interpolation scheme associated with the imaging apparatus 100 is applied to the modified color values to generate a coordinate value corresponding to RGB_{ref}, the coordinate value generated is the same as LAB_{mod} or is closer (e.g. by vector distance) to LAB_{mod} than LAB_{default}. For example, in the case that the interpolation scheme associated with the imaging apparatus 100 is a tetrahedral interpolation scheme, the modified coordinate values may be generated as follows. The barycentric coordinates of the points corresponding to the default coordinate value and the modified coordinate value, in the shape (e.g. tetrahedron) in the second color space enclosing the modified value and the default value may be calculated. These barycentric coordinates correspond to the convex weights applied in combining the coordinate values of the vertices of the enclosing shape when using the tetrahedral interpolation scheme to determine coordinate values for a given enclosed point. These barycentric coordinate values can thus be used as weights for distributing the coordinate value difference among the color values in the first color space associated with the coordinate values of the tetrahedron vertices. Similarly, if an interpolation scheme different than a tetrahedral interpolation scheme is used, the process according to which the coordinate values of the vertices are combined in the interpolation scheme can be applied to update the given values associated with the vertices of the shape.

In the example of FIG. 3b, the RGB values associated with the vertices LAB₁, LAB₂, LAB₃ and LAB₄ are modified to the vertices are updated to RGB_{1′}, RGB_{2′}, RGB_{3′} and RGB_{4′} respectively. While in this example, the values associated with all of the vertices are changed, in some examples one or some of the values may be changed, without all the values being changed.

The color profile of the imaging apparatus 100 may be updated according to the new color values RGB_{1′}, RGB_{2′}, RGB_{3′} and RGB_{4′}, by modifying the first plurality of associates so that the values RGB_{1′}, RGB_{2′}, RGB_{3′} and RGB_{4′} are associated with the values LAB₁, LAB₂, LAB₃, LAB₄, respectively. For example, in the case that the color profile comprises a LUT, the entries for RGB₁, RGB₂, RGB₃ and RGB₄ may be replaced with RGB_{1′}, RGB_{2′}, RGB_{3′} and RGB_{4′}, respectively.

In some examples, the input data indicates a plurality of determined associations between first determined color values of the first color space and respective second determined color values of the second color space, the respective second determined color values representing modified coordinate values of the second color space. For example, the received input data may indicate multiple measured LAB values and associated RGB values. In this case, block 302 described above may involve determining a default value for each of the plurality of determined associations. Block 304 may involve identifying the coordinate value differences between the default coordinate values and respective ones of the modified coordinate values.

Further, in examples, a respective shape in the tessellation of the second color space in which each of the default coordinate values lies is identified. In the case that a first given color value is used to identify more than one of the plurality of default coordinate values, the first given color value is updated based on an average value of the differences corresponding to the more than one of the plurality of default coordinate values. For example, it may be that a more than one of the default coordinate values lies in a given shape in the tessellation. In this case, the average value may be calculated as a mean or weighted mean of the coordinate value differences. A weighted mean may be used if it is desired to give more importance to certain types of colors, such as neutral colors, or colors specified e.g. by a user has having particular importance e.g. brand or corporate identity colors. Alternatively or additionally, because a given vertex is a vertex for multiple shapes in the tessellation, default coordinate values may lie in more than one of these multiple shapes. In this case, a cumulative value of the coordinate value differences may be calculated, and a mean change calculated, by dividing by the number of default coordinate values involved.

In the examples described above with reference to FIG. 3a and FIG. 3b, the first plurality of associations is updated by updating values of the output color space. In other examples, values of the input color space may be updated. In this case, based on the input data, the default value is calculated as a value in the input color space (e.g. RGB space), with other aspects of the processes being modified accordingly.

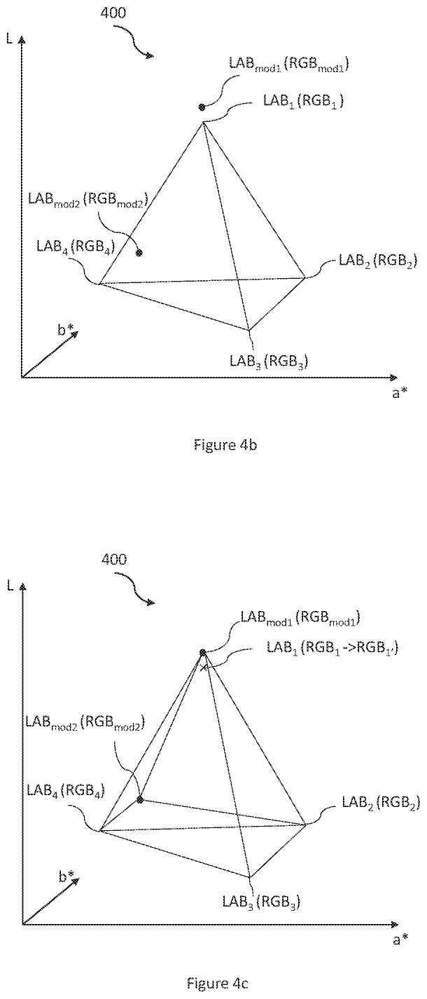

FIG. 4a illustrates a second example update process 400 to update the color profile of an imaging apparatus 100. The second example update process 400 may be used when the interpolation scheme used by imaging apparatus 100, as described above, is not available e.g. not known to the function (e.g. machine-readable instructions) implementing the update process 300.

In common with the first example described above with reference to FIG. 3a and FIG. 3b, the first determined color value may be a coordinate value of the first color space corresponding to the second determined color value, which may be measured value of the second color space and may represent a modified value of the second color space. For example, the modified value is a value desired to be obtained using an interpolation scheme associated with the imaging apparatus 100.

As discussed above, the second plurality of color values may represent coordinate values identifying vertices of shapes forming a tessellation in the second color space. At block 402, the processor 102 determines a modified tessellation in the second color space by setting the modified coordinate value as a vertex of a shape forming the modified tessellation.

FIGS. 4b and 4c illustrate an example of a modification to a tessellation in a second color space, which in this example is a LAB color space. FIG. 4b illustrates a part of the tessellation in the second color space prior to the modification and FIG. 4c illustrates a part of the tessellation in the second color space after the modification. As shown in FIG. 4b, prior to the update process, the tessellated space includes vertices at coordinates LAB₁, LAB₂, LAB₃ and LAB₄, the vertices being associated with RGB values RGB₁, RGB₂, RGB₃ and RGB₄, respectively. The modified color value is added as a point in the second color space. In this example, two modified color values are illustrated LAB_{mod1} and LAB_{mod2}, having corresponding RGB values RGB_{mod1} and RGB_{mod2}, respectively.

In some examples, a coordinate value difference, for example a vector distance, may be determined between the modified coordinate value and a given coordinate value of the second plurality of color values. In the case that the coordinate value difference is less than a predetermined threshold value, the modified tessellation may be determined without using the given coordinate value as a vertex in the modified tessellation. Not including coordinate values having a coordinate value difference less than a threshold in the modified tessellation may maintain a desired spacing of nodes in the color profile, which may improve smoothness of output in response to changes in input and reduce measurement noise.

In the example of FIGS. 4b and 4c, the coordinate value difference LAB_{mod1} and LAB₁ is determined to be less that the threshold value, and so LAB₁ is not used as a vertex in the modified tessellation, as illustrated in FIG. 4c. The coordinate difference between LAB_{mod2} and each of LAB₁ to LAB₄ is determined not to be less than the threshold value, so LAB_{mod2} is included in the modified tessellation. The modified tessellation may be formed by using Delaunay tessellation, for example, in which tetrahedra are formed to generate the tessellated space. In the example of FIGS. 4b and 4c, the modified tessellation is formed from tetrahedra using the modified coordinate value LAB_{mod1}, in addition to the initial coordinate values LAB₂, LAB₂, LAB₃ and LAB₄. The modified tessellation may include a different number of shapes than the tessellation prior to the update process, for example a greater number.

At block 404, the processor 102 performs an interpolation between vertices in the modified tessellation to determine a modified color value of the first color space, corresponding to a given color value of the first plurality of color values. The color value of the first color space which is modified may correspond to a coordinate value of the second color space which is not used as a vertex in the modified tessellation. In the example of FIGS. 4b and 4c, the RGB value corresponding to LAB₁ is updated from RGB₁ to RGB_{1′}). For example, in the modified tessellation LAB₁ may be located in a tetrahedron formed by LAB_{mod1}, LAB₂, LAB₃ and LAB₄, and the corresponding RGB values may be used in an interpolation process using the vertices of the tetrahedron to calculate RGB_{1′}.

As mentioned above, the second example update process 400 may be used when the interpolation scheme used by the imaging apparatus 100 is not available. In this case, a predetermined interpolation scheme, such as a tetrahedral interpolation scheme may be used at block 404. In one example, the tetrahedral interpolation is based on the tetrahedra formed using Delaunay tessellation as described above.

At block 406, the processor 102 associates the updated coordinate value with the given color value of the color profile of the imaging apparatus. In the example, of FIGS. 4b and 4c, the value RGB_{1′} is associated with LAB₁. For example, in the case that the color profile comprises a LUT, the entry for RGB₁ may be replaced with RGB₁′.

It will be appreciated that while FIGS. 4b and 4c illustrate a part of tessellation including one tetrahedron for the unmodified tessellation and two tetrahedra for the modified tessellation, in some examples the tessellation includes many shapes, for example many thousands or millions of shapes. For example, the unmodified tessellation may occupy the whole of the second color space across the whole range of the color profile.

In the examples described above with reference to FIG. 4a to 4c, the first plurality of associations is updated by updating values of the input color space. In other examples, values of the output color space may be updated. In this case, the modified coordinate value is a value in the input color space (e.g. RGB space), and the tessellation which is modified is a tessellation of the input color space, with other aspects of the processes being modified accordingly.

The methods described above provide a way of updating a color profile of an imaging apparatus using an interpolation process involving an existing association between color spaces and data indicating a different association. The different association may be based on measured values and may indicate an accurate correspondence between values of the first color space and values of the second color space. Because an interpolation process is used based on color values which need not already be included in the color profile (e.g. the input data does not need to indicate color values already listed in the color profile), laborious sampling and matching of existing color mappings can be avoided. For example, some existing methods involve comparing the color palette with an expected/desired color palette. This means that only the specific color values (e.g. CIELAB values) in the color profile are updated and made more accurate, or the color profile expanded to include more entries. In contrast, in examples disclosed herein, color values not listed in the color profile may be used as the basis for updating the color profile. This enables the color profile to be updated more accurately to produce any color value within the gamut of the imaging apparatus 100.

Methods according to the above examples may be performed repeatedly, for example at regular intervals, to iteratively improve the accuracy of the imaging apparatus 100. Performing the method periodically may also enable the color profile to be updated to take account of changes in the characteristics of the imaging apparatus over time.

As described above, the first example update process 300 may be used when an interpolation scheme used by the imaging apparatus is known. The first example update process 300 enables a precise update of the color profile because the changes made to the color profile are based on the same interpolation scheme which is subsequently used to generate colors when the imaging apparatus is in use. The second example update process 400 does not need an interpolation scheme associated with the imaging apparatus 100 to be known. The second example update process 400 may also involve fewer processing resources than the first example process update process 300.

In some examples, the processor 102 may determine whether an interpolation scheme associated with the imaging apparatus 100 is available e.g. whether it is stored in the storage medium 104 In the case that the interpolation scheme is determined to be available, an update process according to the first example update process 300 is used. In the case that the interpolation scheme is determined not to be available, an update process according to the second example update process 400 is used.

In the examples herein, where reference is made to a “color value” and a “coordinate value” this includes cases the referred to value comprises multiple values; for example a “coordinate value” may include for example three or four values, corresponding to each axis in the relevant color space. References to “coordinates” may include any suitable type of coordinate, for example cartesian coordinates or barycentric coordinates.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A non-transitory computer readable storage medium having instructions stored thereon, which, when executed by a processor, cause the processor to perform a method of updating a color profile of an imaging apparatus, the method comprising:
retrieving the color profile of the imaging apparatus from data storage, the color profile comprising a first plurality of associations between a first plurality of color values of a first color space and a second plurality of color values of a second color space, one of the first color space and the second color space being a source color space of the imaging apparatus and the other of the first color space and the second color space being a output color space of the imaging apparatus;
receiving input data indicating a determined association, the determined association being an association between a first determined color value of the first color space and a second determined color value of the second color space, the determined association being different from each of the first plurality of associations;
performing an update process to update the first plurality of associations, the update process comprising performing an interpolation process using the input data and an association of the first plurality of associations.

2. The non-transitory computer readable storage medium according to claim 1, wherein the second plurality of color values represent coordinate values identifying vertices of shapes forming a tessellation in the second color space, the second determined color value represents a modified coordinate value of the second color space and the interpolation process comprises:
identifying a default coordinate value of the second color space corresponding to the first determined color value by interpolating, using an interpolation scheme associated with the color profile of the imaging apparatus, based on given values of the first plurality of color values, the given values being associated in the color profile with color values of the second color space representing coordinate values of the vertices a shape containing the default value,
wherein the update process comprises:
identifying a coordinate value difference between the default coordinate value and the modified coordinate value; and
updating the given values of the first plurality of color values based on the coordinate value difference.

3. The non-transitory computer readable storage medium according to claim 2, comprising updating the given values of the first plurality of color values so as to reduce or eliminate the coordinate value difference.

4. The non-transitory computer readable storage medium according to claim 2, wherein the input data indicates a plurality of determined associations between first determined color values of the first color space and respective second determined color values of the second color space, the respective second determined color values representing modified coordinate values of the second color space and the interpolation process comprises:
identifying a plurality of default coordinate values of the second color space corresponding to the first determined color values, by interpolating, using the interpolation scheme, based on a plurality of given values of the first plurality of color values, the plurality of given values being associated in the color profile with color values of the second color space representing coordinate values of shapes containing the default values,
wherein the update process comprises:
identifying coordinate value differences between the default coordinate values and respective ones of the modified coordinate values;
identifying a respective shape in the tessellation in which each of the default coordinate values lies; and
updating the given coordinate values of the first color space so as to reduce or eliminate the coordinate value differences, wherein in the case that a first given value of the plurality of given values is used in the interpolation process to identify more than one of the plurality of default coordinate values, the first given value is updated based on an average value of the differences corresponding to the more than one of the plurality of default coordinate values.

5. The non-transitory computer readable storage medium according to claim 1, wherein the second plurality of color values represent coordinate values identifying vertices of shapes forming a tessellation in the second color space, the second determined color value represents a modified coordinate value of the second color space and the update process comprises:
determining a modified tessellation in the second color space by setting the modified coordinate value as a vertex of a shape forming the modified tessellation,
wherein the interpolation process comprises:
interpolating between vertices in the modified tessellation to determine an updated color value of the first color space corresponding to a given color value of the second plurality of color values;
associating the updated coordinate value with the given color value of the color profile of the imaging apparatus.

6. The non-transitory computer readable storage medium according to claim 5, wherein the interpolation process comprises using tetrahedral interpolation to interpolate between vertices in the modified tessellation.

7. The non-transitory computer readable storage medium according to claim 5, comprising using Delaunay tessellation to determine the modified tessellation.

8. The non-transitory computer readable storage medium according to claim 5, wherein the update process comprises:
determining a coordinate value difference between the modified coordinate value and a given coordinate value of the second plurality of color values; and
in the case that the coordinate value difference is less than a predetermined threshold value, determining the modified tessellation without using the given coordinate value as a vertex in the modified tessellation.

9. The non-transitory computer readable storage medium according to claim 1, wherein the source color space is an RGB or CMYK color space, and second color space is a CIELAB or CIEXYZ color space.

10. The non-transitory computer readable storage medium according to claim 1, wherein the color profile is an international color consortium (ICC) profile.

11. The non-transitory computer readable storage medium according to claim 1, wherein the first plurality of associations is included in a look-up table.

12. A computer-implemented method to update a color profile of an imaging apparatus, by causing a processor to:
retrieve the color profile of the imaging apparatus from data storage, the color profile comprising a first plurality of associations between a first plurality of color values of a first color space and a second plurality of color values of a second color space, the second plurality of color values representing coordinate values identifying vertices of shapes forming a tessellation in the second color space, one of the first color space and the second color space being a source color space of the imaging apparatus and the other of the first color space and the second color space being a output color space of the imaging apparatus;
receive input data indicating a determined association, the determined association being an association between a first determined color value of the first color space and a second determined color value of the second color space, the second determined color value representing a modified coordinate value of the second color space, the determined association being different from each of the first plurality of associations;
update the first plurality of associations by performing an interpolation process using the determined association and an association of the first plurality of associations.

13. The computer-implemented method according to claim 12, wherein the instructions stored on the non-transitory computer readable storage medium, when executed by the processor, cause the processor to:
determine whether an interpolation scheme associated with the color profile of the imaging apparatus is available;
in the case that the interpolation scheme is determined to be available:
identify a default coordinate value of the second color space corresponding to the first determined color value by interpolating between given values of the second plurality of color values using the interpolation scheme,
identify a coordinate value difference between the default coordinate value and the modified coordinate value; and
update, based on the coordinate value difference, color values in the first color space associated with the given values of the second plurality of color values, and in the case that the interpolation scheme is determined to be not available:
determine a modified tessellation in the second color space by setting the modified coordinate value as a vertex of a shape forming the modified tessellation;
interpolate between vertices in the modified tessellation to determine a modified coordinate value of the second color space corresponding to a given color value of the first plurality of color values;
associate the modified coordinate value with the given color value in the color profile of the imaging apparatus.

14. An apparatus to update a color profile, the apparatus comprising:
a data storage to store the color profile, the color profile comprising a first plurality of associations between a first plurality of color values of a first color space and a second plurality of color values of a second color space, one of the first color space and the second color space being a source color space of an imaging apparatus and the other of the first color space and the second color space being a output color space of the imaging apparatus;
an interface to receive input data indicating a determined association, the determined association being an association between a first determined color value of the first color space and a second determined color value of the second color space, the determined association being different from each of the first plurality of associations;
a processor performing an update process to update the first plurality of associations, the update process comprising performing an interpolation process using the determined association and an association of the first plurality of associations.

15. The apparatus according to claim 14, comprising a printing apparatus.
